(19) United States
(12) Patent Application Publication
(10) Pub. No.: US 2008/0008231 A1
(43) Pub. Date: Jan. 10, 2008

(54) COMMUNICATIONS SYSTEM

(75) Inventors: Haifeng Wang, Shanghai (CN); Fang Wang, Nanjing (CN); Ming Chen, Nanjing (CN); Shixin Cheng, Nanjing (CN)

Correspondence Address: FOLEY & LARDNER LLP, P.O. BOX 80278, SAN DIEGO, CA, 92138-0278, US

(73) Assignee: Nokia Corporation

(21) Appl. No.: 11/738,908

(22) Filed: Apr. 23, 2007

(30) Foreign Application Priority Data
Jul. 10, 2006 (GB) GB 0613686.5

(51) Int. Cl. H04L 27/28; H04B 1/38; H04L 5/16; H04K 1/10

(52) U.S. Cl. 375/219; 375/260; 375/295; 375/316

(57) ABSTRACT

A method of transmitting data in a communications system comprising a first station and a second station. The method for transmitting data in a communications system comprises encoding data; allocating the encoded data to different quality channels based on how data is encoded; and transmitting the encoded data on the allocated channels from the first station to the second station.

### CROSS-REFERENCE TO RELATED PATENT APPLICATIONS

The present application claims priority to Great Britain Priority Application GB 0613686.5, filed Jul. 10 2006 and incorporated herein by reference in its entirety.

### FIELD OF THE INVENTION

The present invention relates to a communication system and more particularly, but not exclusively, to an Orthogonal Frequency Division Multiplexing (OFDM) system that uses low density parity check codes.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Wireless communications systems of a cellular nature are well known, where a network entity in the form of a base station is responsible for communication with user equipment in one or more cells or sectors. When an user equipment moves from one cell or sector to another cell or sector, handover techniques ensure that the communication is not lost as responsibility is passed to a different base station. There are many different techniques for processing signals for transmission between the base station and the user equipment, and the precise handover techniques which are used depend on these systems.

One technique for handling multi-carrier transmissions is orthogonal frequency division multiplexing (OFDM). Orthogonal frequency-division multiplexing (OFDM) offers the advantages of improved downlink system capacity, coverage and data rates for packet data services with high spectral efficiency due to a nearly rectangular spectrum occupancy and low-cost implementation using the Fast Fourier Transform (FFT). It has been exploited for wideband data communications over mobile radio channels, high bit rate digital subscriber lines (HDSLs), asymmetric digital subscriber lines (ADSLs), digital broadcasting, and wireless local area network (WLAN) in IEEE 802.11n and worldwide interoperability for microwave access (WIMAX) in IEEE 802.16e. OFDM partitions the entire bandwidth into parallel independent sub-carriers to transmit parallel data streams. The relatively long symbol duration and guard interval provide greater immunity to intersymbol interference (ISI). Recently it received considerable attention as an air interface for evolution of UMTS mobile radio systems in the 3GPP (Third Generation Partnership Protocol) standardization forum.

Communication systems such as OFDM employ coding to enhance the reliability of communication over noisy channels. One such error correction code system uses low density parity check (LDPC) codes.

Low-Density parity check (LDPC) codes are a class of linear block codes, which provide near-capacity performance on a large set of data transmission and storage channels. These codes have proven to be serious competitors to turbo codes in terms of their error correcting performance. Also, LDPC codes exhibit an asymptotically better performance than turbo codes and also admit a better trade-off between performance and decoding complexity.

An LDPC code can be represented by a bipartite graph. For an (N, K) LDPC codes, the bipartite graph consists of N variable nodes (represent the bits of the codeword), N-K check bits (corresponding to parity check equations), and a certain number of edges between these two types of nodes. The term “degree” of a node is the number of edges connected to this node. If all the variable nodes have a same degree j, and all the check nodes have a same degree k, this code is referred to as a “regular” LDPC code. Otherwise, if the variable or check nodes have different degrees, the code is called an “irregular” LDPC code.

Irregular LDPC codes are typically described as ensembles with variable and check edge polynomials

$$λ ( x ) = {\sum }_{i = 2}^{{d}_{l}} {λ}_{i} {x}^{i - 1} and ρ ( x ) = {\sum }_{j = 2}^{{d}_{r}} {ρ}_{j} {x}^{j - 1} ,$$

respectively, where λᵢ and ρⱼ are the fraction of total edges connected to variable and check nodes of degree i=2, 3, . . . , dₗ and j=2, 3, . . . , dᵣ respectively. Thus, some random irregular LDPC constructions based upon edge ensemble designs have error correcting capabilities measured in Bit Error Rate (BER) that are within 0.05 dB of the rate-distorted Shannon limit.

Further advantages of LDPC codes include low complexity, full parallelizable decoders and detectable decoding errors.

V. Mannoni et al describe in Proc. IEEE PIMRC 2002 a method of optimizing the structure of LDPC codes for transmission over a frequency selective fading channel. According to this method a differential evolution optimization algorithm is used. Although this method improves the system performance it is impractical in dynamic environments. Furthermore the transmitter has to re-optimize the algorithm to find the optimal degree profile by exhaustive operations.

It is therefore an aim of embodiments of the present invention to optimize the advantages of LDPC codes in an OFDM system.

### SUMMARY OF THE INVENTION

According to a first aspect of the present invention there is provided a method of transmitting data in a communications system comprising a first station and a second station, the method comprising the steps of encoding data; allocating the encoded data to different quality channels based on how data is encoded; transmitting the encoded data on the allocated channels from the first station to the second station.

According to a second aspect of the invention there is provided a method of transmitting data in a communication system comprising the step of transmitting data on different quality channels in dependence on how the data is encoded.

According to a third aspect of the invention there is provided a transmitter comprising an encoder for encoding data, receiving means for receiving channel information, channel allocation means for allocating data to different quality channels in dependence on the channel information, and transmitting means for transmitting data on the allocated channels.

According to a fourth aspect of the present invention there is provided a receiver comprising receiving means for receiving data, transmitting means for transmitting channel information for the received data, ordering means for reordering data to the order in which the data was encoded based on the channel information, and decoding means for decoding the data.

According to a fifth aspect of the invention there is provided a communications system comprising a first station and a second station, wherein the first station is arranged to encode data and transmit the encoded data to the second station on different quality channels in dependence on how the data is encoded, and wherein the second station is arranged to determine channel information, order the encoded data to an order in which it was encoded based on the channel information, and to decode the data.

According to a sixth aspect of the present invention there is provided a communications system comprising a first station and a second station, the first station arranged to order encoded data from a first order to a second order in dependence on channel information received from the second station and to transmit the data to the second station; and the second station is arranged to order the data from the second order to the first order in dependence on order information derived from the channel information.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

For a better understanding of various embodiments of the present invention and to show how the same may be carried into effect, reference will now be made by way of example to the accompanying drawings in which:

FIG. 1 is a schematic diagram of a cellular wireless communications system;

FIG. 2 is a schematic diagram showing communication between user equipment, base station and radio network controller;

FIG. 3 is a block diagram of a conventional OFDM transceiver;

FIG. 4 is a block diagram of an OFDM transceiver according to an embodiment of the present invention;

FIGS. 5(a) and 5(b) are graphs showing an instance of degree distribution in subcarriers after ordering;

FIG. 6 is a graph illustrating the bit error rate (BER) performance of an OFDM system embodying the present invention; and

FIG. 7 is a graph showing the impacts of quantization on CSI feedback signaling;

FIG. 8 is a flow chart showing the method steps according to an embodiment of the invention.

### DETAILED DESCRIPTION OF THE PREFERRED EMBODIMENTS

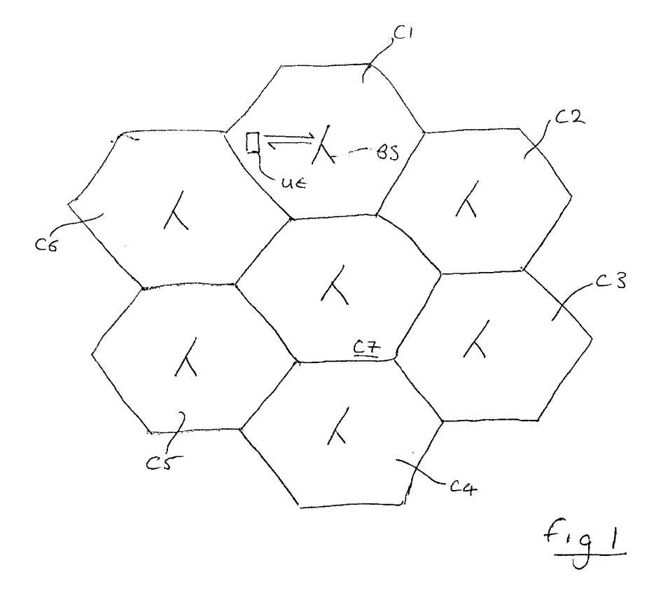

FIG. 1 illustrates a cellular wireless communications network of which seven cells C1 . . . C7 are shown in a “honeycomb” structure. Each cell is shown managed by a base station BS which is responsible for handling communications with user equipment (UE) located in that cell. Although one base station per cell is shown in FIG. 1, it will readily be appreciated that other cellular configurations are possible, for example with a base station controlling three cells. Also, other arrangements are possible, including a network divided into sectors, or a network where each cell is divided into sectors. User equipment UE1 communicates with the base station BS via a wireless channel 2 having an uplink and a downlink. The base station BS is responsible for processing signals to be communicated to the user equipment UE and as will be described in more detail in the following.

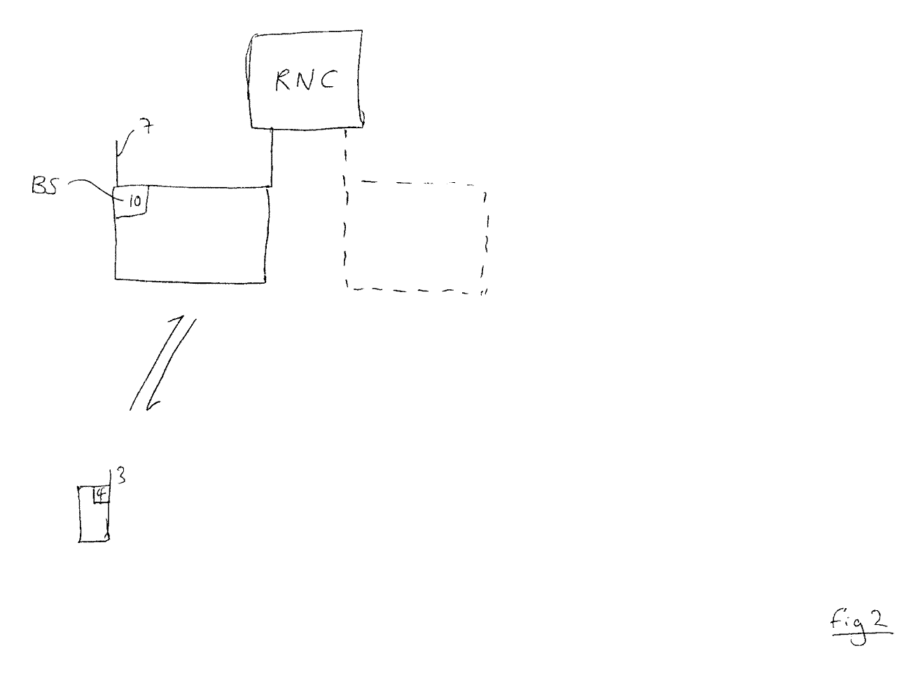

FIG. 2 is a schematic block diagram showing a user equipment in communication with a base station, and also showing a radio network controller RNC which manages the operation of a plurality of base stations in a manner known in the art. The user equipment UE comprises an antenna 3 connected to a transceiver 4. The base station also has an antenna 7 connected to a transceiver 10. The radio network controller RNC is connected to the base station BS and to other base stations indicated diagrammatically by the dotted line.

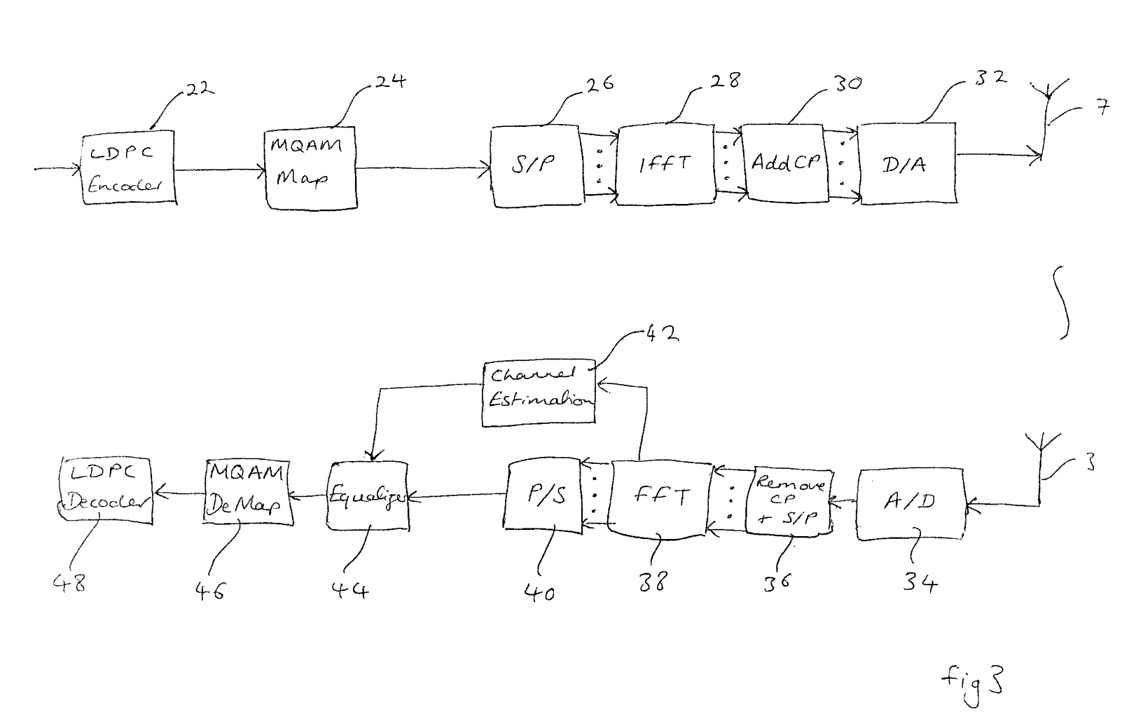

Reference will now be made to FIG. 3 to describe a conventional OFDM transceiver structure. FIG. 3 shows the transmitter section of the transceiver 10 of the base station BS and the receiver section of the transceiver 4 of the user equipment UE. It will be readily appreciated that the transmitter and receiver sections described may be present in both the BS and UE.

FIG. 3 shows a block diagram of the conventional OFDM transceiver. The information bits are encoded at LDPC encoder 22 and output as codewords. The bits of the codewords are mapped onto modulation symbols Sₖ by a MQAM (M-Order Quadrature Amplitude Modulation) mapper 24. After a serial to parallel conversion at S/P block 26, the complex symbols are modulated into subcarriers by an N points IFFT (Inverse Fast Fourier Transform) operation at block 28. The OFDM symbols are then sampled every T_{c} second and converted from parallel to serial. Block Add CP 30 then inserts a cyclic prefix (CP) between OFDM symbols. The output is then up-converted to the carrier frequency and transmitted. The symbol is transmitted over several subcarriers. The transmitted symbols in the time domain can be expressed as:

$${s}_{n} = \sqrt{E ( s )} / \sqrt{N} {\sum }_{k = 0}^{N - 1} S ( k ) exp j ( \frac{2 π k n}{N} ) , n = 0 , 1 , … , N - 1$$

where E(s) is the energy per symbol. N is the number of subcarriers, j is the square root of −1 and k is the subcarrier index.

The discrete-time received signal can be written as
yₙ=sₙ\textcircled{×}hₙ+nₙn=0,1, . . . ,N−1
where sₙ is the transmitted signal, hₙ is the channel impulse response and n_{n,} is the additive white Gaussian noise (AWGN).

In the above conventional OFDM transceiver it is assumed that the channel impulse response is unchangeable during an OFDM symbol period. The CP is removed and the signal is converted from serial to parallel at block 36. After the signal is processed by an N-points FFT (Fast Fourier Transform) operation at block 38, the frequency domain signal can be written as
Yₖ=Sₖ.Hₖ+Nₖ,k=0,1, . . . ,N−1
where Hₖ is the channel frequency domain response and Nₖ is the AWGN at the k-th subcarrier.

Frequency-domain received signals Yₖ, can be equalized by one-tap equalizer 44 based on the channel state information (CSI) estimation. The signal is then demapped from symbol level to bit level by MQMA De-map block 46 and eventually decoded by LDPC decoder 48 using the BP algorithm.

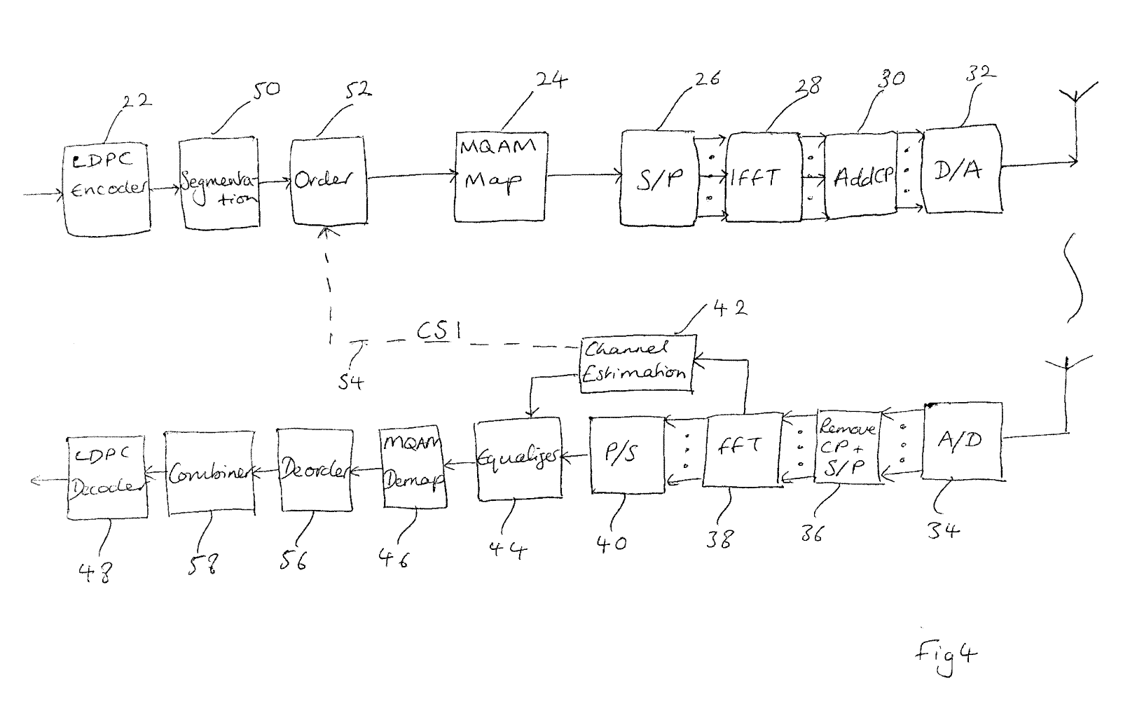

Reference will now be made to FIG. 4 which shows a block diagram of a transceiver structure according to an embodiment of the present invention. Like reference numerals are used to identify components as illustrated in FIG. 3. Again, FIG. 4 shows the transmitter section of the transceiver 10 in the base station BS and the receiver section of the transceiver 4 in user equipment UE. The description may apply to the transceivers in both the base station BS and the user equipment UE.

As shown in FIG. 4 the transceiver further includes a segmentation block 50 and an order block 52 in the transmitter, and a combiner block 58 and deorder block 56 in the receiver.

At the transmitter K_{c} information bits are encoded by the LDPC encoder into N_{c} coded bits X_{kc}, k_{c}=1, 2, . . . , N_{c} with the code rate of: R=K_{c}/N_{c}

The encoded bits are output from the encoder as codewords. Usually the output LDPC codeword is too long to be transmitted in a single OFDM symbol. In this case it is necessary to segment the LDPC codeword into sub-blocks in order to map the coded bits onto an OFDM symbol. According to one embodiment of the invention the sub-block contains 1024 coded bits.

Each bit encoded by the encoded by the encoder has a particular degree. According to an embodiment of the invention a LDPC encoded bit may have a degree of 2, 3 or 9. The proportion of each type degree in a codeword is referred to as the degree distribution of the codeword.

In one embodiment of the invention, if a sequence of bits in a codeword is to be transmitted in more than one OFDM symbol, the segmentation block 50 performs an inner interleave function to insure the degree distribution of bits in each sub block is the same as the degree distribution of the bits in the whole codeword. Interleave operations are known in the art and will not be described further herein.

At segmentation block 50 the codewords are segmented into sub-blocks of size: N·log₂M, where N is the subcarrier number and M is the modulation constellation size. According to an embodiment of the invention, any type of modulation may be used. Typically in a 3GPP LTE (3rd Generation Partnership Project for the Long Term Evolution) system N is valid from 128 to 1024 based on the bandwidth, while M may range from 2 for BPSK to 6 for 64 QAM. Thus N_{c}=a·N·log₂M, where a is the number of sub-blocks.

The a blocks are then input into order block 52, before being mapped into N symbols Sₖ, k=0, 1, . . . , N−1 at MQAM mapper block 24.

It should be noted that although the number of symbols has been set as equal to the number of subcarriers in this embodiment, in other embodiments of the invention the number of symbols may not be equal to the number of subcarriers. For example, in another embodiment of the invention, some of subcarriers may be utilized as virtual carriers or by other users.

As shown in FIG. 4, channel state information (CSI) 54 is fed back to the transmitter of the base station BS from the Channel Estimation unit 42 in the receiver of the user equipment UE. This information may be provided on a feedback channel.

In an alternative embodiment of the invention the channel information may be determined at the transmitter. In this embodiment another channel estimation method may be used, for example in Time Division Duplexing (TDD) systems, CSI information may be provided in the reciprocal uplink and downlink communications. The CSI may include full channel information, time delay and power spectrum of each path, or the frequency response of the channel as well as channel attenuation information.

According to an embodiment of the invention, when the sub-blocks are input into the order block 52, the coded bits in each sub-block are ordered according to their degrees and to the channel attenuation of each subcarrier contained in channel state information (CSI).

The order block 52 uses the CSI to determine the channel attenuation of each subcarrier and order the encoded bits according to its degree such that when the bits are eventually modulated onto subcarriers the bits with higher variable degrees are allocated to subcarriers with less attenuation.

The ordered bits are then input into the MQAM mapper 24 where they are mapped into symbols Sₖ.

As known in the art, an OFDM symbol is transmitted on a plurality of subcarriers. According to an embodiment of the invention, the symbols are modulated onto the subcarriers by an IFFT operation at block 28. As a result of ordering the bits in each sub-block at order block 52, the higher and lower modulated bits are segmented in the frequency domain such that the modulated symbols containing bits with higher variable degrees, are allocated to subcarriers with less attenuation. Conversely, the modulated symbols containing bits with lower variable degrees, hereinafter referred to as symbols with lower variable degrees, are allocated to subcarriers with greater attenuation.

After the symbols have been modulated onto subcarriers the cyclic prefix (CP) is added, before being up-converted and transmitted.

It should be noted that embodiments of the present invention are particularly suited to, although not limited to, a quasi static fading environment since it is not necessary to transmit the CSI information as often when the channel does not vary very fast.

When the signal is received at the receiver of the user equipment UE, the signal is converted from an analogue signal to a digital signal at block 34. The CP is removed at block 36. After, the signal is processed by an FFT operation at block 38 into a frequency domain signal.

The frequency-domain received signal, is equalized at equalizer 44 based on the channel state information (CSI) estimation provided to the equalizer by the channel estimation block 42. The CSI is also provided to the transmitter via a feedback signal for the purpose of ordering. In an embodiment of the present invention quantization of the feedback signal is applied to reduce the signaling overhead. The inventors have that shown using simulations that quantization induced performance loss is negligible.

The signal is then input into MQAM de-map block 46 where it is de-mapped from symbol level to bit level. The coded blocks are then input into De-order block 56 where they are reordered into their original order using CSI provided by the channel estimation block 42.

The combiner 58 performs the opposite operation to the segmentation block 50 in the transmitter. Accordingly, when a whole codeword is transmitted in more then one OFDM block, the reordered coded bits are combined into a whole codeword at Combiner 58 before being decoded at LDPC Decoder 48.

FIG. 8 is a flow chart showing the general method steps according to an embodiment of the invention.

At S1 the data is encoded at the first station. The encoding may encode different bits of the data differently, for example the encoded bits may have variable degrees as previously discussed.

At S2 the encoded data is allocated to different quality channels based on how the data is encoded.

At S3 the encoded data is transmitted on the allocated channels from the first station to the second station.

Table 1 below summarizes the performances of an ordered LDPC coded OFDM system according to an embodiment of the invention. The system was simulated and evaluated in quasi-static frequency-selective fading channel with perfect channel estimation. The parity check matrices of LDPC code are generated according to the Progressive Edge Growth (PEG) method, (as described in X. Y. HU, E. Eleftheriou, and D. M. Arnold, “Regular and irregular progressive edge-growth Tanner graphs,” IEEE Trans. Inform. Theory, vol. 51 no. 1, pp. 376-398, January 2005), and the codes are decoded by BP decoding algorithm with 100 iterations.

TABLE 1

| | |
|---|---|
| Subcarrier number | N = 1024,512 |
| LDPC code length | N_{c} = 1024 |
| Carrier frequency | f_{c} = 5 GHz |
| Sample frequency | fₛ = 10 MHz |
| CP number | 64 |
| Channel | ITU-R M.1125 |
| Mobile velocity | 100 k/h |
| Time delay | 0, 310, 710, 1090, 1730, 2510 ns |
| Power spectrum | 0, −1, −9, −10, −15, −20 dB |
| SNR | 0 dB |
| λ(x) (column weight) | 0.27684x + 0.28342x² + 0.43974x⁸ |

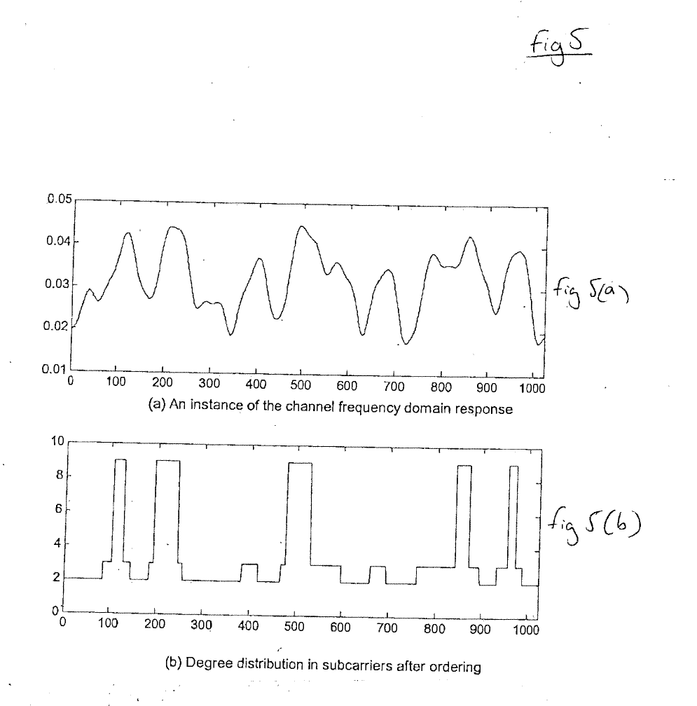

Reference is now made to FIG. 5 which shows further results for simulations embodying the present invention. FIGS. 5(a) and 5(b) are graphs showing an instance of degree distribution in subcarriers after ordering. FIG. 5(a) shows a real time channel impulse response in frequency domain. FIG. 5(b) is the degree distribution of the symbols transmitted after the ordering operation in all the subcarriers.

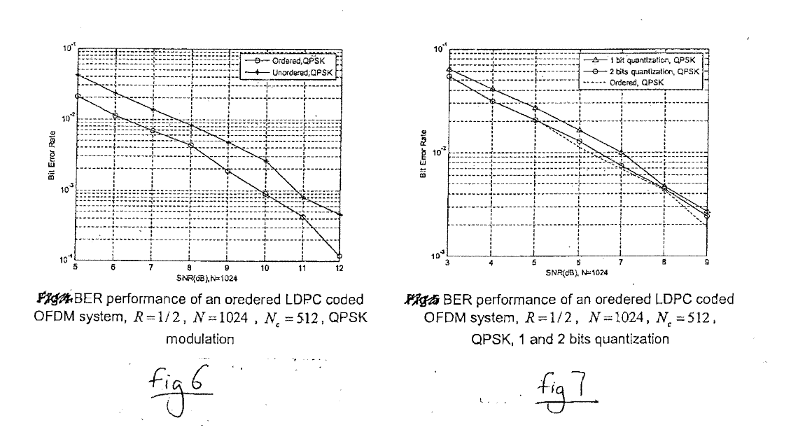

FIG. 6 is a graph illustrating the bit error rate (BER) performance of an OFDM system embodying the present invention, having QPSK modulation (M=4) and N_{c}=512. It should be noticed that the system according to various embodiments of the present invention has an improved performance of approximately 1.5 dB compared to the conventional transceiver system.

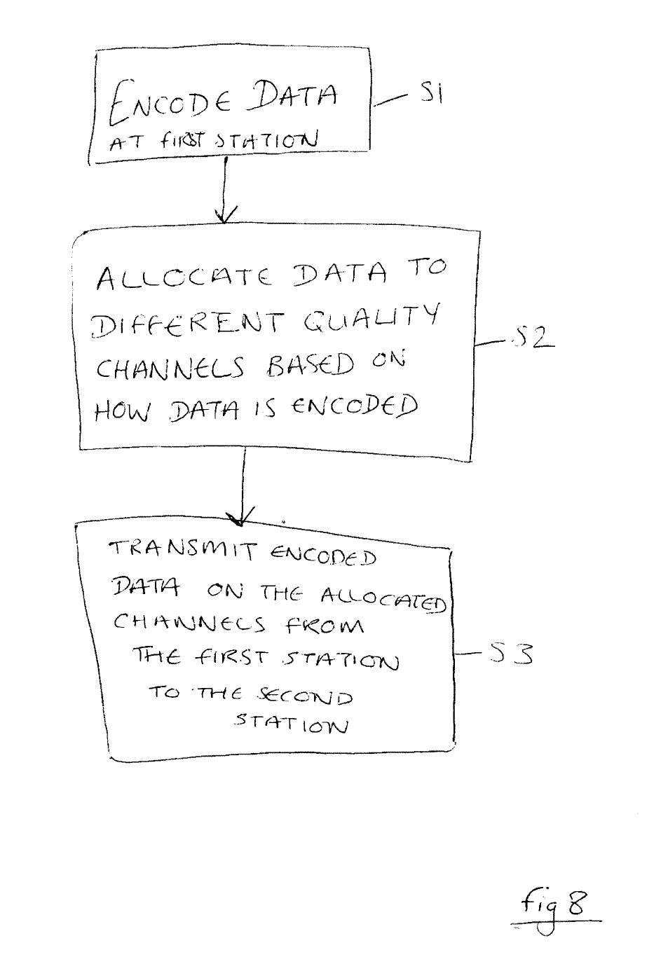

FIG. 7 is a graph showing the impacts of quantization on CSI feedback signaling. It can be seen that the proposed scheme is robust to the CSI feedback errors. Generally the number of quantization bit ω should satisfy the condition that 2^{ω}≧δ(dᵥ), where δ(dᵥ) is the class number of column weight of the LDPC code. For example δ(dᵥ)=3 implies that ω=2 is sufficient. It has been shown that by employing only 2-3 quantization bits to represent the feedback CSI there is negligible performance loss compared to the using an ideal feed back signal without quantization.

From the above results it can be seen that embodiments of the present invention significantly improve the bit error rate (BER) performance of OFDM systems.

It should be appreciated that embodiments of the invention may also be used in relation to other types of encoding such as Zigzag encoding. In the case of zigzag encoding parity zigzag encoded bits may be modulated onto a highly attenuated subcarrier, whereas systematic zigzag encoded bits may be modulated onto a less attenuated subcarrier.

It should also be appreciated that embodiments of the present invention may be used in other types of communication systems, such as a Bell Labs Layered Space-Time (BLAST) antenna system. According to this embodiment encoded bits with higher degrees can be placed on the less attenuated antennas.

Embodiments of the invention may be applied to any encoding scheme whereby one encoded bit contributes differently than another encoded bit to the decoding process.

Embodiments of the invention may also be applied to any encoding scheme whereby one encoded bit is more robust to error when being decoded than another encoded bit.

The required data processing functions in the above described embodiments of the present invention may be implemented by either hardware or software. All required processing may be provided in a controller provided in the transmitter and in the receiver, or control functions may be separated. Appropriately adapted computer program code product may be used for implementing the embodiments, when loaded to a computer. The program code product for providing the operation may be stored on and provided by a carrier medium such as a carrier disc, card or tape. Implementation may be provided with appropriate software in a control node. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The applicant draws attention to the fact that the present invention may include any feature or combination of features disclosed herein either implicitly or explicitly or any generalization thereof, without limitation to the scope of any of the present claims. In view of the foregoing description it will be evident to a person skilled in the art that various modifications may be made within the scope of the invention.

What is claimed is:

1. A method of transmitting data in a communications system comprising a first station and a second station, the method comprising:
encoding data;
allocating the encoded data to different quality channels based on how data is encoded; and
transmitting the encoded data on the allocated channels from the first station to the second station.

2. A method as claimed in claim 1, wherein channel quality is determined from channel information received from transmitted from the second station.

3. A method as claimed in claim 1, wherein encoded data with higher variable degrees. is allocated to channels with higher quality.

4. A method as claimed in claim 1, wherein data is ordered in the second station such that the data is decoded in the order it was encoded.

5. A method as claimed in claim 2, wherein encoded data is allocated onto channels by ordering the encoded data in a channel allocation order based on the channel information.

6. A method as claimed in claim 4, wherein the data is reordered at the second station from a channel allocation order to the order in which it was encoded based on channel information.

7. A method as claimed in claim 6, wherein the channel information is determined at the second station.

8. A method as claimed in claim 2, wherein the channel information is transmitted from the second station to the first station.

9. A method as claimed in claim 1, wherein the data is encoded by an LDPC encoder.

10. A method as claimed in claim 5, wherein the channel allocation order of the encoded data is determined according to the degree of LDPC code.

11. A method as claimed in claim 2. wherein the channel information relates to the channel attenuation of each sub-carrier.

12. A method as claimed in claim 11, wherein the data is allocated in the channel allocation order such that the encoded data with a higher variable degree is allocated to sub-carriers with less attenuation.

13. A method as claimed in claim 5, wherein the determining of the channel allocation order comprises:
determining the attenuation of each channel; and
ordering the encoded data in the channel allocation order such that the data with higher variable degrees is allocated to subcarriers with less attenuation.

14. A method as claimed in claim 13, wherein the encoded data is segmented into data blocks before the data is ordered in the channel allocation order.

15. A method of transmitting data in a communication system, comprising:
transmitting data on different quality channels in dependence on how the data is encoded.

16. A method as claimed in claim 15, wherein the encoded data with a higher variable degree is modulated onto higher quality channels.

17. A method as claimed in claim 15, wherein the encoded data with a lower variable degree is modulated onto lower quality channels.

18. A transmitter, comprising
encoding means for encoding data,
receiving means for receiving channel information,
channel allocation means for allocating the data into different quality channels in dependence on the channel information, and
transmitting means for transmitting the data on the allocated channels

19. A receiver comprising;
receiving means for receiving data;
transmitting means for transmitting channel information for the received data, ordering means for reordering the data to the order in which the data was encoded based on the channel information; and
decoding means for decoding the data.

20. A transmitter, comprising
an encoder for encoding data,
a receiver for receiving channel information,
a channel assignor for allocating the data in to different quality channels in dependence on the channel information, and
a transmitter for transmitting the data on the allocated channels.

21. A transmitter as claimed in claim 20, wherein the channel assignor allocates the data in dependence on how the data is encoded.

22. A transmitter as claimed in claim 20, wherein the transmitter allocates the data to different quality channels by ordering the data into a channel allocation order.

23. A transmitter as claimed in claim 20, wherein the transmitter further comprises a segmentor arranged to segment the data into data blocks before the data is ordered in the channel allocation order.

24. A receiver, comprising;
a receiver for receiving data;
a transmitter for transmitting channel information for the received data,
a selector for reordering the data to the order in which the data was encoded based on the channel information; and
a decoder for decoding the data.

25. A receiver as claimed claim 24, further comprising a determiner for determining the channel information.

26. A transceiver comprising the transmitter of claims 20 and a receiver, the transmitter including:
an encoder for encoding data,
a receiver for receiving channel information,
a channel assignor for allocating the data in to different quality channels in dependence on the channel information, and
a transmitter for transmitting the data on the allocated channels.

27. A communications system, comprising:
a first station; and
a second station, wherein the first station is configured to encode data and transmit the encoded data to the second station on different quality channels in dependence on how the data is encoded, and wherein the second station is configured to determine channel information, order the encoded data to an order in which it was encoded based on the channel information, and decode the data.

28. A communication system as claimed in claim 27, wherein the second station is further configured to transmit channel information to the first station.

29. A communications system, comprising:
a first station; and
a second station,
wherein the first station is to order encoded data from a first order to a second order in dependence on channel information received from the second station and to transmit the data to the second station, and wherein the second station is configured to order the data from the second order to the first order in dependence on order information derived from the channel information.

30. A computer program, embodied in a computer-readable medium, comprising program code for performing of the processeses of claim 1 when the computer program is run on a processor.
